(19) United States
(12) Patent Application Publication
(10) Pub. No.: US 2007/0125003 A1
(43) Pub. Date: Jun. 7, 2007

(54) Motor vehicle door

(76) Inventors: Sandro Wartzack, Hallstadt (DE); Markus Schultz, Nurnburg (DE); Thomas Pohl, Grossenseebach (DE); Manfred Stenzel, Bamberg (DE); Ralph Dillenburger, Vilafranca (ES); Jose Cuenca, Rubi (ES); Christian Schramm, Guardiola de Font-Rubi (ES); Manfred Frei, Barcelona (ES); Martin Schlechtriemen, Breitengussbach (DE)

Correspondence Address: CHRISTIE, PARKER & HALE, LLP, PO BOX 7068, PASADENA, CA, 91109-7068, US

(21) Appl. No.: 10/560,140

(22) PCT Filed: Jun. 9, 2004
(86) PCT No.: PCT/DE04/01236

§ 371 Date: Sep. 20, 2006

(30) Foreign Application Priority Data
Jun. 10, 2003 (DE) 0313364.2
Jun. 16, 2003 (DE) 0313942.5
Jul. 24, 2003 (DE) 10334143.9

(51) Int. Cl. E06B 7/16

(52) U.S. Cl. 49/502; 49/475.1

(57) ABSTRACT

An automobile door comprises an outer module having a car body shell and forms an outer design surface of said automobile door, in addition to a unit carrier that is arranged on the side of the outer module facing the interior of the motor vehicle and that is connected to said outer module forming an interface. A sealing extends along the interface between the unit carrier and the outer module, said sealing covering the interface at least partly.

### CROSS-REFERENCE TO A RELATED APPLICATION

This application is a National Phase patent application of International Application Number PCT/DE2004/001236, filed on Jun. 9, 2004, which claims priority of German Patent Application Number 103 34 143.9, filed on Jul. 24, 2003.

### BACKGROUND

The invention relates to a motor vehicle door.

A motor vehicle door of this kind comprises an outer module which has a door outer shell and forms an outer design surface of the motor vehicle door, as well as a unit carrier which is mounted on the side of the outer module facing the interior of the vehicle and is connected to same to form an interface, as well as supports electrical and/or mechanical functional components of the motor vehicle door.

The outer module of the vehicle door consequently provides the appearance which is visible from outside of the motor vehicle and is as a rule painted the same colour as the remaining areas of the vehicle body. The unit carrier mounted on the inside of the outer module serves more particularly to house the electrical and mechanical functional components which are provided on the vehicle door, such as for example a lock assembly, a window lifter, a speaker, a side airbag module etc. It is thereby particularly advantageous to pre-assemble all the electrical and mechanical functional components of this kind on the unit carrier so that they can be brought together with the unit carrier into one door module which can be pre-assembled and pre-checked as one complete unit which can be connected later on to the outer module.

Since the unit carrier is not visible from outside of the vehicle when the vehicle door closed it does not form a constituent part of the outer design face of the vehicle door. Also the unit carrier can as a rule not be visible from inside the vehicle when the vehicle door is closed since it is normally covered by a door inside trim which is adapted in design to the other surfaces of the vehicle interior, such as e.g. the dashboard, roof etc.

When the vehicle door is opened however the interface along which the outer module of the vehicle door and unit carrier are connected together can be seen along the front and/or rear end side of the vehicle door. By interface is thereby meant that region of the vehicle door along which the outer module of the vehicle door and the unit carrier bear against each other. In this region there is a sharp transition from the outer module which is adapted to the external design of the motor vehicle, to the unit carrier which is formed for example through a door inside panel painted in a neutral colour and which is generally not subject to any particular design specifications since (at least when the vehicle door is closed) it is visible from neither outside of the vehicle nor from inside the vehicle.

The object of the invention is to provide a motor vehicle door of the type mentioned at the beginning where the configuration of the transition area from the outer module to the unit carrier of the motor vehicle is improved.

### BRIEF DESCRIPTION

According to this a sealing member extends along the interface between the unit carrier and outer module of the door thereby covering the interface.

The solution according to the invention is based on the knowledge that the irregular sharp transition from the door outer module to the unit carrier can be avoided by using a sealing member which is in any case required along the vehicle door to cover this transition area. This can be in particular the so-called door main seal by which the vehicle door in the closed state bears with sealing action against the vehicle body, e.g. the so-called A-pillar and B-pillar to prevent damp and wet from entering into the motor vehicle. Furthermore this seal can also produce a sealing connection between the unit carrier and the outer module.

According to a preferred embodiment of the invention at least some of the fixings, e.g. screws or rivets which are used to connect the unit carrier to the door body are covered by the said sealing member. This involves in particular covering those fixings or those areas of the fixings which would if not covered be visible to the person looking at the fully fitted (opened) vehicle door.

Furthermore the sealing member can likewise cover elements of a reference point system which serves to align the individual structural modules of the vehicle door. It is thereby ensured that the interface, the fixing means as well as the elements of the reference point system cannot be seen from inside the vehicle, thus by an occupant seated in the vehicle, as the vehicle door is opened.

A further preferred embodiment of the invention is characterised in that the sealing member as a whole or at least a section of the sealing member can be moved so that the fixings serving to connect the unit carrier and outer module are no longer covered and are therefore exposed for actuation by a suitable tool. Thus in the event of a repair or service the connection between the unit carrier and door outer shell can be released to allow access to such functional components of the vehicle door which are mounted in the door inside space (so-called wet space of the vehicle door) which is provided between the unit carrier and the door outer shell. This particularly relates to those vehicle components which are mounted on the surface of the unit carrier facing the door outer shell (wet-space side). These are typically those functional components of the vehicle door which have no special sensitivity to moisture, such as e.g. the lever mechanics of a window lifter, or which are stored in a moisture-tight housing. Those functional components of the vehicle door which must not come into contact with damp are consequently as a rule mounted on the surface of the unit carrier facing the interior of the vehicle (and thus remote from the door outer shell)—dry-side surface—and are covered there by a door inside trim.

The particularly preferred further development of the invention described above is particularly suitable in vehicle doors having removable outer modules, i.e. those vehicle doors where the outer module has sufficient inherent stability so that the outer module when removed from the unit carrier can be set down separately when carrying out service and repair work. In this case suitable detachable fixings are provided for connecting the outer module and unit carrier. Furthermore there is the advantage that the stable outer module can be painted together with the vehicle body and then the unit carrier can be connected to the outer module. Furthermore there is the possibility of simply exchanging the outer module in the event of minor damage.

According to one variation of the invention moving the sealing member in order to release the fixings is carried out by folding the sealing member round. For this the sealing member has a pivotal region, e.g. in the form of a bending or hinged area about which the section of the sealing member covering the fixing elements can be folded in order to free the fixing elements. The sealing member is thereby preferably pretensioned as a result of the inherent elasticity so that the section of the sealing member serving to cover the fixing elements has the tendency to lie over the fixing elements and has to be folded back away from same against this elastic pretension.

According to another embodiment of the invention the sealing member can be displaced on a supporting base, namely on the associated fixing region of the vehicle door on which the sealing member is fixed so that the fixings covered by the sealing member and serving to connect the unit carrier and outer module are released.

With both the variations mentioned above there is the possibility each time of moving the sealing member away from the fixings which are to be released by a folding or sliding movement without having to release the sealing member from the vehicle door. The sealing member is only brought by folding (only a section of the sealing member) or sliding into a position where it no longer covers the fixings which are to be actuated.

In order to fix the sealing member on the vehicle door a fixing region of the vehicle door is used to which the sealing member can be fixed for example with positive locking action. The positive locking connection can be on the one hand a push-fit connection where a recess is provided on the sealing member which can be pushed onto a corresponding web-type fixing region of the vehicle door, e.g. an angled end of the unit carrier. On the other hand a separate fixing rail can also be mounted on the vehicle door into which the sealing member can be inserted or pushed by a section (fixing foot) which serves for fixing.

Alternatively or additionally it can be proposed that the sealing member is clamped by a section serving for fixing between the outer module and the unit carrier. The fixing means serving to fix the unit carrier and outer module, e.g. in the form of screws or rivets can hereby also engage through the seal and additionally ensure fixing on the corresponding fixing region of the motor vehicle door. Particularly if the sealing member is designed to produce a push-fit connection in its section serving for fixing on the vehicle door it can be advantageous to reinforce this section of the sealing member by a metal insert.

According to one embodiment of the invention the sealing member is prefitted on the unit carrier before the unit carrier and outer module are assembled together. The sealing member can hereby be fixed on the unit carrier first in a first position (pre-assembly position) in which it still does not cover the fixing points which serve to fix the outer module on the unit carrier. Only after connecting the outer module with the unit carrier is the sealing member then moved into a second position (function position) in which it covers the fixing points. This simplifies assembly when connecting the outer module and unit carrier. It is thereby also possible for the sealing member to be removed at the assembly site of the vehicle door from the first position which serves only as a transport position and then fitted and fixed again in its second position serving as the function position after the unit carrier and outer module are connected together. According to another variation the sealing member is prefitted on the unit carrier already in its function position; it can however be moved or folded round for connecting the outer module and unit carrier so that the fixing points required for this are released. The elasticity of the sealing member can be used particularly for this. In order to actuate the fixing means the sealing member is folded up about its longitudinal axis so that there is sufficient access. According to a further variation the sealing member is stuck onto a fixing region of the unit carrier.

According to a second embodiment of the invention the sealing member is only fitted and fixed on the vehicle door after the unit carrier and outer module have been connected together.

In order to fix the sealing member, positive locking regions can be provided (moulded) on the unit carrier, particularly in its edge region, to enable a positive locking fixing of the sealing member on the unit carrier.

Furthermore a door inside trim can be provided (pre-fitted) on the unit carrier to cover the unit carrier in its area visible to the inside of the vehicle. The parts of the door which are not painted in the colour of the bodywork, namely the regions of the unit carrier pointing towards the inside of the vehicle are hereby covered, if they are not already covered by the sealing member. Furthermore additional frame fascia panels can be provided to cover corresponding areas of the door body.

In a preferred embodiment the sealing member is designed so that it also covers the interface between unit carrier and door inside trim. An expensive custom-fitted cutting of the ends of the door inside trim mounted on the unit carrier can hereby be omitted. When fixing the sealing member to the unit carrier or to the outer module the sealing member has a corresponding projection which protrudes from the sealing member towards the door inside trim and thereby covers the interface with the unit carrier. On the other hand it can also be proposed that the sealing member is fixed on the door inside trim and then extends with a projection from there to the interface between the unit carrier and outer module in order to cover this as well according to the invention.

As already mentioned above the present invention is particularly suitable for use in a motor vehicle door whose door outer shell has an increased inherent stability so that this is not first stabilised by the assembly with the door inside skin (i.e. the unit carrier), but that it also can be handled and stored as a structural assembly which is separated from the door inside trim or unit carrier. For this the outer module has in the region of its outer edge reinforcement areas so that this has through the combination of a door outer shell (in the form of a thin door outer panel or a door outer paneling consisting of plastics) with the reinforcement regions sufficient inherent strength that it can be handled as a separate door module which is independent of the unit carrier.

The outer module can hereby be painted separately prior to assembly with the unit carrier. This enables for example a common painting of the outer module of the vehicle door together with the remaining bodywork of the associated motor vehicle in one uniform painting process so that a uniform colouring of the vehicle bodywork on the one hand and the outer shell of the associated vehicle doors on the other is ensured. At the same time the additional constituent parts of the motor vehicle door, more particularly the unit carrier can be made at any chosen location completely independently of the outer module, provided with further functional components and pre-checked whereby one door module is produced which is formed from the unit carrier and the function components prefitted thereon.

The unit carrier with the door components prefitted thereon is then transported to the assembly site of the motor vehicle where the unit carrier and the outer module of the vehicle door are connected together (preferably detachably). The vehicle door which is hereby completed can then be installed in the motor vehicle provided for same.

Furthermore there is the possibility of detaching the outer module again from the unit carrier at a later date in the event of service or repair in order to obtain access from outside the vehicle to those door components which are mounted on the wet-space side surface of the unit carrier facing the outer module. This is made easier through the preferred variations described above for forming the sealing member which covers the fixings of the outer module and unit carrier enabling release of the fixings for actuation through a tool.

The reinforcement areas preferably protrude inwards from the outer module, i.e. towards the unit carrier and run along the edge of the outer module. The reinforcement areas can thereby be formed on the one side integral along the door outer shell or alternatively form a separate structural unit which is fixed on the door outer shell. The corresponding separating structural unit forms a frame-type intermediate or reinforcement plate which is fixed on one side on the door outer shell and through which on the other side the door outer shell is connected to the door inner shell (the unit carrier) of the vehicle door.

The reinforcement regions comprise in particular a front and rear reinforcement element which each extend on the front and rear end side along the vertical vehicle axis (in relation to the position of the door installed in a motor vehicle) and which forms the end side of the vehicle door. Furthermore additional reinforcement elements can be provided on the upper edge of the door outer shell (door shaft reinforcement underneath the window opening) as well as on the lower edge of the door outer shell (towards the vehicle floor), which each extend in the longitudinal direction of the vehicle.

The reinforcement regions can according to one embodiment form a one-piece reinforcement frame which is fitted onto the door outer shell as a complete e.g. fully circumferential or U-shaped reinforcement frame. On the other hand the reinforcement areas can however also be formed by individual separate reinforcement elements which are fixed separately on the outer module and then form there a reinforcement frame after assembly.

For fixing on the door outer shell the reinforcement regions preferably have an angled end section which is engaged by a folded end of the door outer shell. In addition the connection can be secured by adhesive or welding.

To fix the door outer shell to the unit carrier through the reinforcement regions the latter have a further angled section which serves to fix the unit carrier.

In the case of an outer module made from plastics or metal, more particularly metal plate, the reinforcement regions can also be formed directly on the door outer shell, e.g. in the case of metal by deep drawing or stamping.

Furthermore a cross support can be mounted on the outer module or unit carrier to extend across over the inside of the door outer shell or unit carrier and serve to reinforce the vehicle door in the event of crash conditions.

The unit carrier can have a frame structure with an integrated window frame. This frame structure surrounds a large-surface support plate of the unit carrier which serves to house the electrical and mechanical functional components of the vehicle door, and furthermore forms a window opening.

The unit carrier is preferably designed with a large surface area so that it extends up to the side edges of the motor vehicle door. The unit carrier hereby differs from the conventional door module supports which are fitted onto a recess in the door inside panel of a motor vehicle door and consequently lie completely inside the outer edges of the vehicle door and extend up to same.

The unit carrier can also have in the region of its outer edge reinforcement areas which preferably protrude outwards from same, i.e. in the direction of the outer module and which can either be formed integral on same or can be formed by separate reinforcement elements. The reinforcement areas of the unit carrier can form at the same time a part of a frame structure of the unit carrier.

Furthermore the outer module of the vehicle door and the unit carrier can be placed in contact against each other through their reinforcement areas whereby the reinforcement areas have in addition fixing points for connecting the outer module and unit carrier.

The unit carrier can be made independently of the outer module and independently of the remaining bodywork of the relevant motor vehicle at a separate location and in a colour independent of the colouring of the motor vehicle. For the outside appearance of the motor vehicle door designed according to the invention is determined through the outer module which is consequently to be painted in a uniform colour together with the remaining areas of the vehicle bodywork.

In order to stabilise the overlapping region in which the unit carrier and the outer module are connected together (more particularly through the reinforcement areas of the outer module), the connection is provided along an overlapping region which in cross-section is angled at least once, whereby fixings are provided to connect the unit carrier and outer module either side of the angle. An overlapping region which is made stable in this way and which is used to connect the unit carrier and outer module is particularly suitable to hold a door lock which is fixed on this overlapping region. Since when slamming the vehicle door or in the event of a crash considerable forces can appear at the door lock which are then directed into the vehicle body a correspondingly stable fixing of the door lock to the vehicle door is particularly important.

According to a further preferred development of the invention the door lock is prefitted on the unit carrier, i.e. it is fixed on this prior to assembly with the outer module and is still fixed in addition on that overlapping region after fitting the unit carrier and outer module together. By prefitting the door lock on the unit carrier it is thereby ensured that after the unit carrier and outer module are assembled together the door lock is mounted in a correct position inside the vehicle door and then it is only necessary to actuate the fixing elements which are provided for the additional fixing on the overlapping region.

Furthermore in the overlapping region of the unit carrier and outer module a hinge part can be fixed through which the vehicle door is connected to the door body so that it can be lifted up or pivoted. By fixing the hinged part to a correspondingly reinforced overlapping region it is possible to omit additional reinforcement parts when fixing the hinge on the vehicle door. Obviously however a fixing outside of the overlapping region is also possible by using suitable reinforcement parts. A direct force introduction to the door inside part can thereby be ensured whereby it leads to a relaxation of the connection points between the unit carrier and outer module. The direct connection of the lock furthermore ensures a direct force introduction into the vehicle body.

In order to stabilise and reinforce the connection between the unit carrier and outer module the unit carrier can be turned round at least at a part of the fixing points which serve to connect with the outer module so that the material of the unit carrier at the fixing points is made as a double layer. There is preferably no doubling of the material of the unit carrier between the fixing points but a design of this edge region is such that this is suitable for holding or fixing the door seal.

### BRIEF DESCRIPTION OF THE DRAWINGS

Further features and advantages of the invention will now be explained in the following description with reference to embodiments in the drawings.

FIG. 1a is a first perspective view of a motor vehicle door consisting of a unit carrier and an outer module connected thereto.

FIG. 1b is a second perspective view of a motor vehicle door consisting of a unit carrier and an outer module connected thereto.

FIG. 1c is a third perspective view of a motor vehicle door consisting of a unit carrier and an outer module connected thereto.

FIG. 1d is a fourth perspective view of a motor vehicle door consisting of a unit carrier and an outer module connected thereto.

FIG. 2a shows the unit carrier of FIGS. 1a to 1d.

FIG. 2b shows the outer module of FIGS. 1a to 1d.

FIG. 3 is an exploded view of a vehicle door according to FIGS. 1a to 1d.

FIG. 4a is a diagrammatic view of the connection region between the outer module and unit carrier.

FIG. 4b is a detailed view of the connection region according to FIG. 4a.

FIG. 5a is a view of the connection region between unit carrier and outer module with a lock assembly mounted in the connection region.

FIG. 5b is a modification of the arrangement of FIG. 5a.

FIG. 6a is a view of the connection region of the unit carrier and outer module with an additional hinge part in the connection region.

FIG. 6b is a modification of the arrangement of FIG. 6a.

FIG. 7a is a further development of the connection region between unit carrier and outer module with special fixing regions for the door seal on one side and for the connection between outer module and unit carrier on the other side.

FIG. 7b is a further development of the connection region between unit carrier and outer module with special fixing regions for the door seal on one side and for the connection between outer module and unit carrier on the other side.

FIG. 7c is a further development of the connection region between unit carrier and outer module with special fixing regions for the door seal on one side and for the connection between outer module and unit carrier on the other side.

FIG. 8 is a first embodiment for fixing a door sealing member in the connection region between the unit carrier and outer module.

FIG. 9 is a second embodiment for fixing a door sealing member in the connection region of the unit carrier and outer module.

FIG. 10 is a third embodiment for fixing a door sealing member in the connection region of the unit carrier and outer module.

FIG. 11 is a fourth embodiment for fixing a door sealing member in the connection region between unit carrier and outer module.

FIG. 12 is a fifth embodiment for fixing a door sealing member in the connection region between unit carrier and outer module.

### DETAILED DESCRIPTION

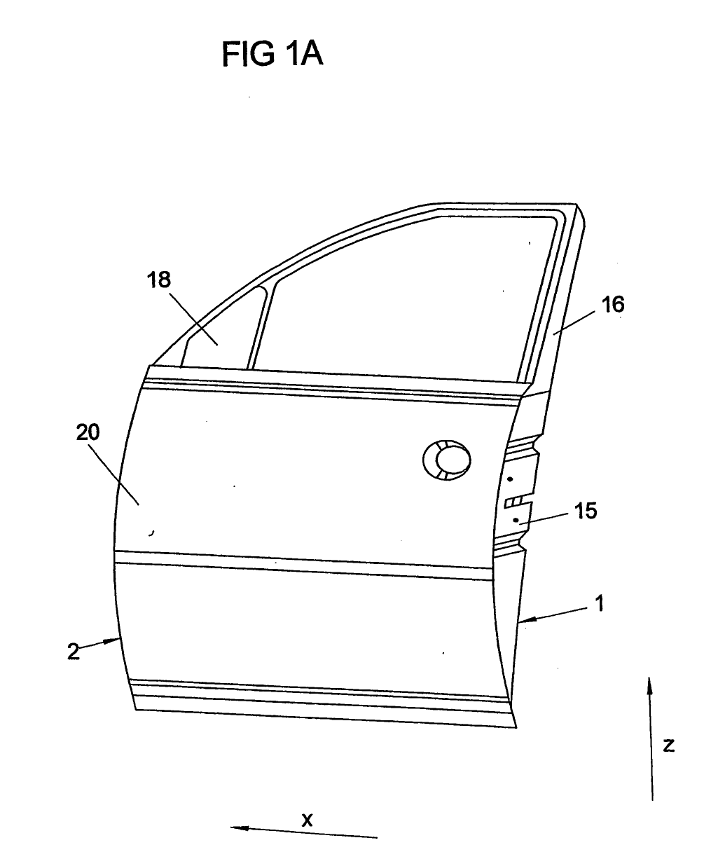

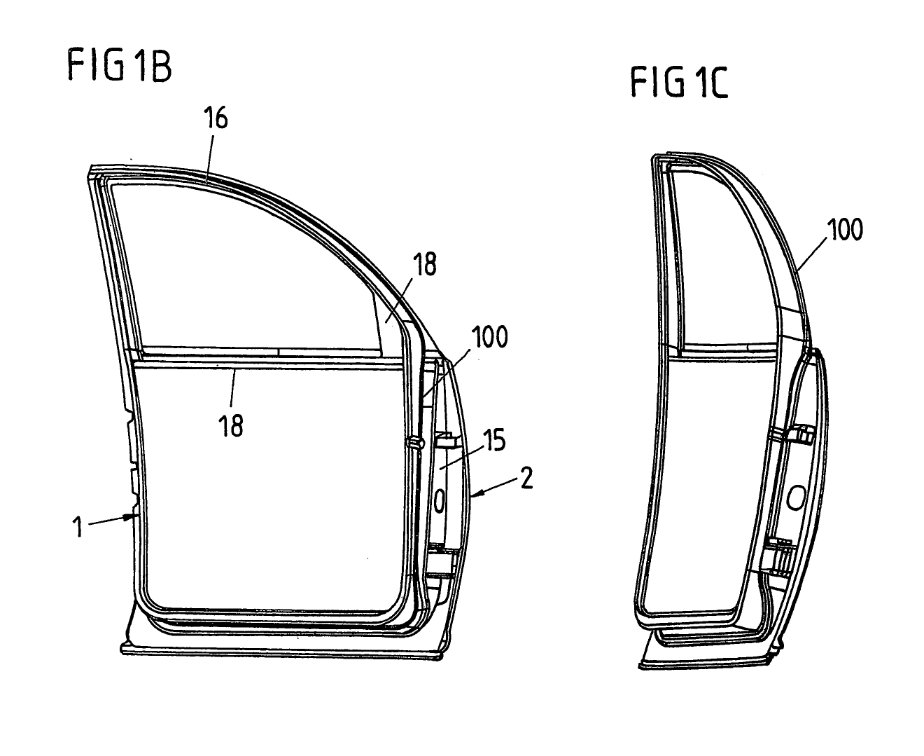

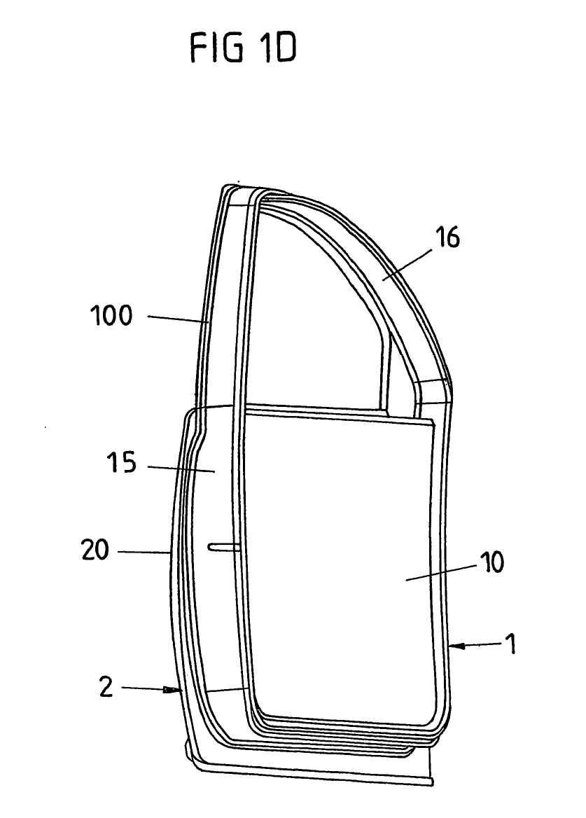

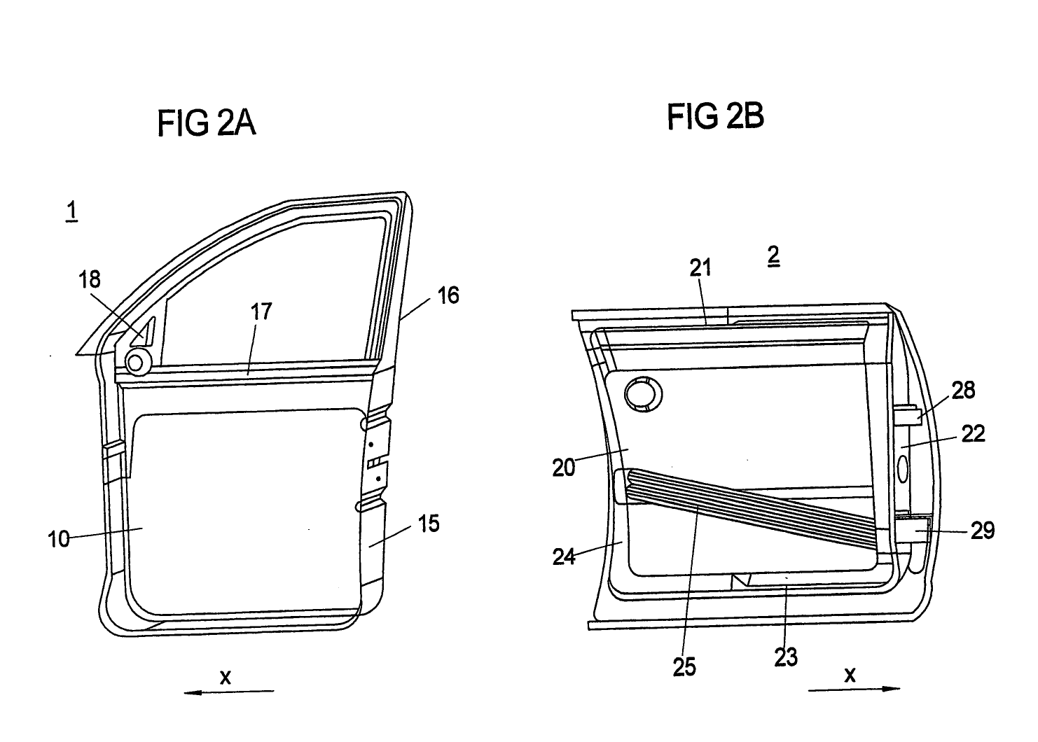

FIGS. 1a to 1d show a vehicle door which consists of a unit carrier 1 shown separately in FIG. 2a, and an outer module 2 shown separately in FIG. 2b.

The unit carrier 1 is formed by a support plate 10 made of metal (sheet metal), on the lower, front and rear edge areas of which, in the vehicle longitudinal direction x, reinforcement areas 15 are formed by stamping or deep-drawing to protrude outwards, i.e. towards the outer module 2. These reinforcement areas 15 form at the same time a frame which surrounds the support plate 10 U-shaped. Furthermore the support plate 10 has a reinforced ledge area 17. The U-shaped reinforcement and frame region 15 of the unit carrier 1 is adjoined at the top by a window frame 16 which defines and surrounds an opening for a window pane in the normal way.

The unit carrier 1 furthermore has a so-called mirror triangle 18 between the door ledge 17 and the window frame 16. Furthermore a sealing member 100 is prefitted on the peripheral frame parts 15, 16 of the unit carrier 1 to serve on the one side as the door main seal through which the vehicle door when closed bears against the door body. On the other side the sealing member 100 also serves to seal the connection between the unit carrier 1 and outer module 2. Furthermore the seal can also serve as damping means for outside noises (sound).

The outer module 2 is formed by an outer paneling 20 (outer shell) which is provided in the region of its outer edge all round with a reinforcement plate in the form of a reinforcement frame 21, 22, 23, 24. Each of the four regions 21, 22, 23, 24 of the reinforcement plate runs along an edge area of the outer shell 10 and protrudes inwards from the door outer shell 2, i.e. towards the unit carrier 1. As a result of the reinforcement areas 21 to 24 the outer module 2 has sufficient inherent stability so that it can be handled and painted independently of the unit carrier 1.

Between the two side (end-side) reinforcement areas 22, 24 of the outer module 2, seen in the vehicle longitudinal direction, and extended along the vertical vehicle axis z extends a cross support 25 (side impact support) which serves to reinforce the outer module 2 and thus the vehicle door as a whole in the event of a side crash. The longitudinal extended cross support 25 is fixed by its front and rear end to one of the two end-side reinforcement areas 22, 24. Furthermore two hinges 28, 29 are mounted on the front side end reinforcement region 22 in the vehicle longitudinal direction x through which the vehicle door can be connected with hinged action to the vehicle body.

As a result of the inherent rigidity of the outer module 2 of the vehicle door the latter can be made independently of the unit carrier, provided with hinges 28, 29 and painted on its outer paneling 20. The painting is preferably carried out together with the remaining areas of the vehicle body in a uniform painting process so that deviations in the colour shade of the vehicle door on the one hand and the remaining areas of the vehicle body on the other are avoided. The said manufacturing, assembly and painting steps can be undertaken by the manufacturer of the corresponding motor vehicle.

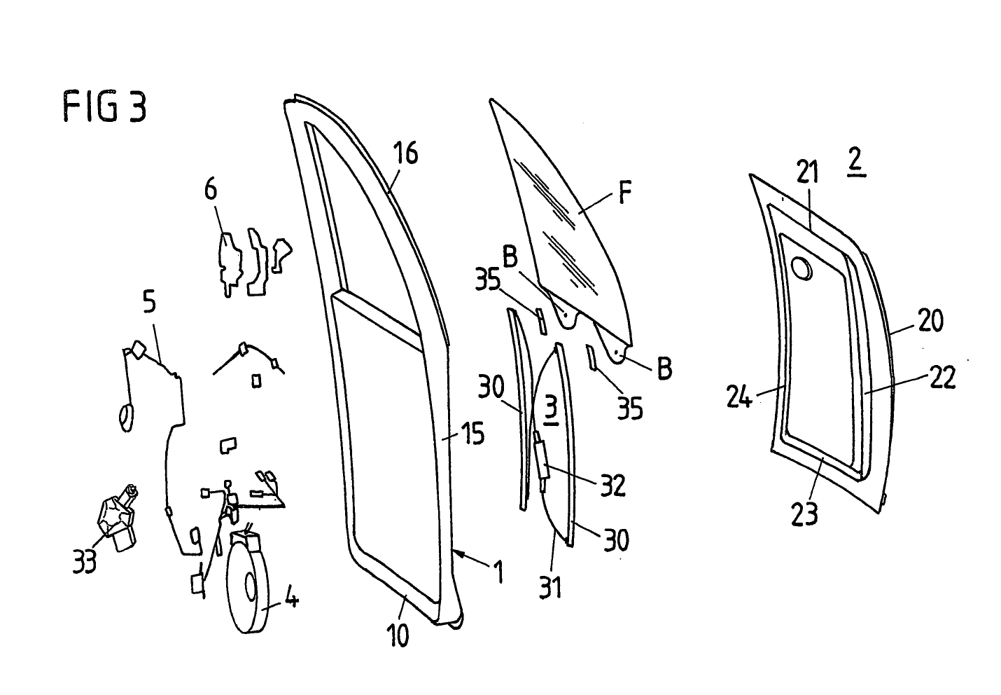

Independently of this the unit carrier 1 can be prepared at a separate site, e.g. at a suppliers of the corresponding vehicle manufacturer. For this the electrical and mechanical function components provided on the vehicle door are prefitted on the support plate 10 of the unit carrier 1, as will be described in further detail below with reference to FIG. 3. Furthermore a door sealing member 100 is fitted onto the unit carrier 1 along the frame parts 15, 16 thereof to ensure inter alia as the main door seal a sealed contact between the vehicle door and the vehicle body. The colour of the unit carrier 1 can be selected independently of the colour of the outer module 2 and in particular need not coincide with the colour used to paint the bodywork of the corresponding motor vehicle. In particular a neutral colour such as e.g. white, grey or black, is suitable for this, or the interior colour of the corresponding motor vehicle.

The structure of the motor vehicle door illustrated in FIGS. 1a to 1b will be explained with reference to the exploded view of FIG. 3. The unit carrier 1 with a support plate 10 and frame regions 15, 16 which surround the support plate 10 on one side and define a window frame on the other serves to hold an electric window lifter 3, speaker 4, several cable strands 5 as well as a further structural group 6. The mechanical elements of the window lifter 3, namely guide rails 30, Bowden cable 31, gearing unit 32 as well as followers 35 guided by the Bowden cable 31 along the guide rails 30 are mounted on the wet space side of the support plate 10 i.e. on the surface facing the outer module 2. A window pane F can be fixed on the two followers 35 of the window lifter 3 and has for this on the underneath two fixing regions B each with a fixing opening.

On the dry space side of the unit carrier 1, i.e. on the side facing the inside of the vehicle the drive motor 33 of the window lifter, the speaker unit 4, the cable strands 5 as well as the further structural unit 6 are mounted on the support plate 10. Such further structural units which can be prefitted on the support plate 10 can be for example a lock unit, side airbag module, armrest etc.

The aforementioned function elements 3, 4, 5, 6 of the vehicle door are prefitted on the support plate 10 before this is connected to the outer module 2. This also applies to the window pane F which is connected to the window lifter 3 through its fixing regions B and the followers 35. The unit carrier 1, the further function elements 3 to 6 as well as the window pane F thus form in the pre-assembled state one substantially complete door module which comprises all the pre-fittable door elements apart from the door outer shell.

The door outer shell 20 is integrated into a separate outer module 2 of the vehicle door which as a result of its reinforcement regions 21 to 24 has sufficient inherent stiffness to be handled and more particularly painted independently of the unit carrier 1.

The assembly of the unit carrier 1 and the function components 3 to 6, F prefitted thereon with the outer module 2 forms the final assembly step during the manufacture of the vehicle door as a whole.

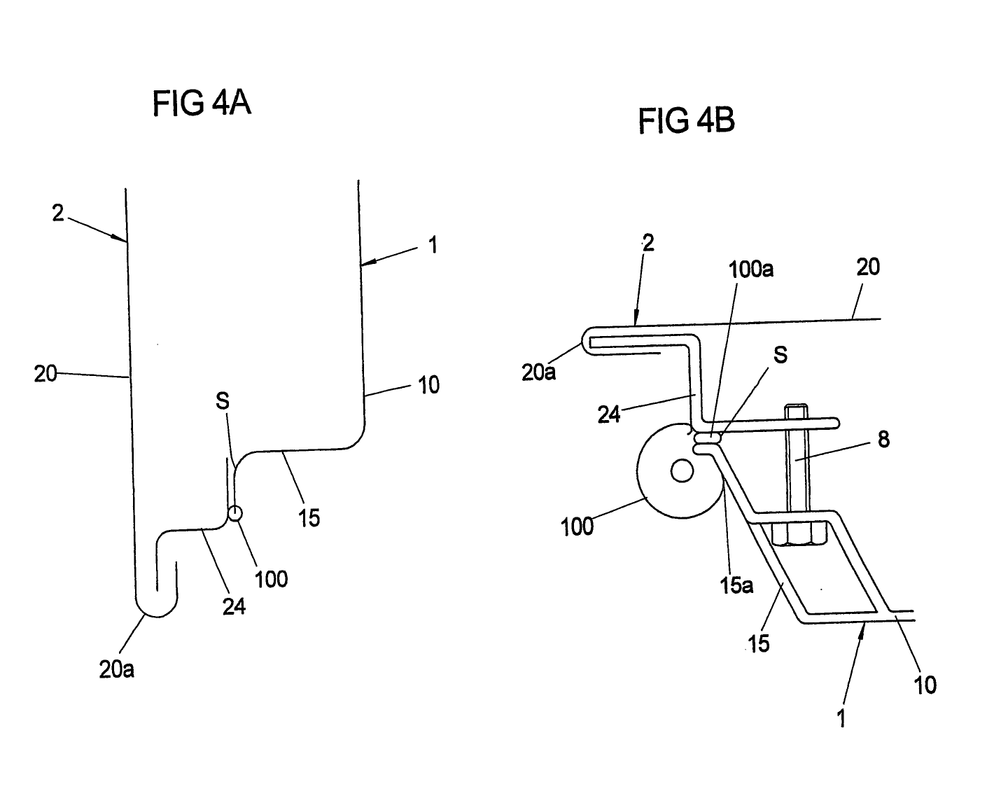

FIG. 4a shows diagrammatically the interface S between unit carrier 1 and the outer module 2 with the door outer shell 20. The door outer shell 20 has on its edge 20a an inwardly folded material region which serves to fix a rear reinforcement region 24. The angled reinforcement region 24 can thereby be clamped between the door shell 20 and the folded edge region 20a. Additionally or alternatively a connection can be produced by adhesive, welding, screws, rivets or other suitable fixing methods. The further reinforcement regions 21, 22, 23 of the outer module 2 (see FIG. 2b) are connected in a corresponding manner to the outer paneling 20 and ensure the special inherent rigidity of the outer module 2.

The reinforcement regions 21 to 24 of the outer module 2 also form a part of the door inner panel of the vehicle door which is completed through the support plate 10 of the unit carrier 1. The support plate 10 of the unit carrier 1 has on its side edge area reinforcement regions 15 which protrude outwards i.e. towards the outer module 2 and which at the same time form frame areas (frame parts) of the unit carrier 1 and serve to fix the unit carrier 1 on the outer module 2.

The reinforcement 15 of the unit carrier 1 as well as the reinforcement region 24 of the outer module 2 are each angled so that they form mutually contacting faces through which the outer module 2 is connected to the unit carrier 1. The corresponding interface is covered by the sealing member 100 which also serves as the main door seal.

Further details of a concrete design of the interface S between the unit carrier 1 and outer module 2 can be derived from FIG. 4b. According to this the reinforcement region 15 of the unit carrier 1 as well as the reinforcement region 24 of the outer module 2 are connected together through fixings 8 in the form of screws which each engage through fixing openings in the two reinforcement regions 15, 24.

Furthermore the reinforcement region 15 of the unit carrier 1 has at its free end a fixing region 15a in the form of a fixing flange on which the sealing member 100 can be positively fitted so that it can be pre-fitted on the unit carrier 1. After connecting the unit carrier 1 and outer module 2 the seal 100 is furthermore clamped by a section 100a between the fixing regions 15, 24. On the one hand the connection between unit carrier 1 and outer module 2 is hereby sealed and furthermore the sealing member 100 is held secure. It can further be seen from FIGS. 4a and 4b that the sealing member 100 covers the interface S between unit carrier 1 and outer module 2 so that the interface S is sealed and not visible to a person looking at the vehicle door when the door is opened.

The embodiment described above of a door unit comprising a unit carrier 1 and outer module 2 can be modified in many different ways.

Thus the two-piece structure can also be selected for frameless vehicle doors; in this case the unit carrier 1 has no window frame.

The reinforcement regions 15 of the unit carrier 1 on one side and the reinforcement regions 21 to 24 of the outer module on the other can be made from different materials and have different material thicknesses. As a rule with the unit carrier 1 a higher strength is required than in the case of the outer module 2 so that the reinforcement regions 21 to 24 of the latter can have a thinner material thickness and/or be made from a lighter less stable material.

The reinforcement regions 15, 22 to 24 of the unit carrier 1 as well as of the outer module 2 can furthermore have guide regions to make it easier to position the two parts 1, 2 relative to each other so that assembly becomes easier. Furthermore the reinforcement regions can also serve as window guides for a drop-down window pane and the section of the unit carrier serving as the window frame can have a glass channel.

The sealing member which is mounted on the interface between the unit carrier 1 and outer module 2 can serve at the same time also to connect the outer module 2 to the unit carrier 1. For this suitable fixing means are integrated in the sealing member to become active on pressing the sealing member into the region of the interface S between unit carrier 1 and outer module 2, e.g. in that they engage in corresponding fixing points on the unit carrier 1 and/or the outer module 2 and hereby produce a positive and/or force locking connection. On the other hand fixing means which are separate from the sealing member can be prefitted on one of the two parts, more particularly on the unit carrier 1 before the unit carrier 1 and outer module 2 are fitted together. It is then not necessary to provide separate fixing means at the assembly site where the unit carrier 1 and outer module 2 are connected together.

The door inside trim with which the unit carrier 1 is covered from the inside of the vehicle can be fixed in the region of the interface between unit carrier 1 and outer module 2 whereby it engages at least in part round the reinforcement regions 15, 21 to 24 at the edge for example. An undercut section is hereby formed which enables a simple secure fixing of the door inside trim. The fixing of the door inside trim on the edge of the reinforcement regions can be produced by positive-locking, force-locking or other fixing means.

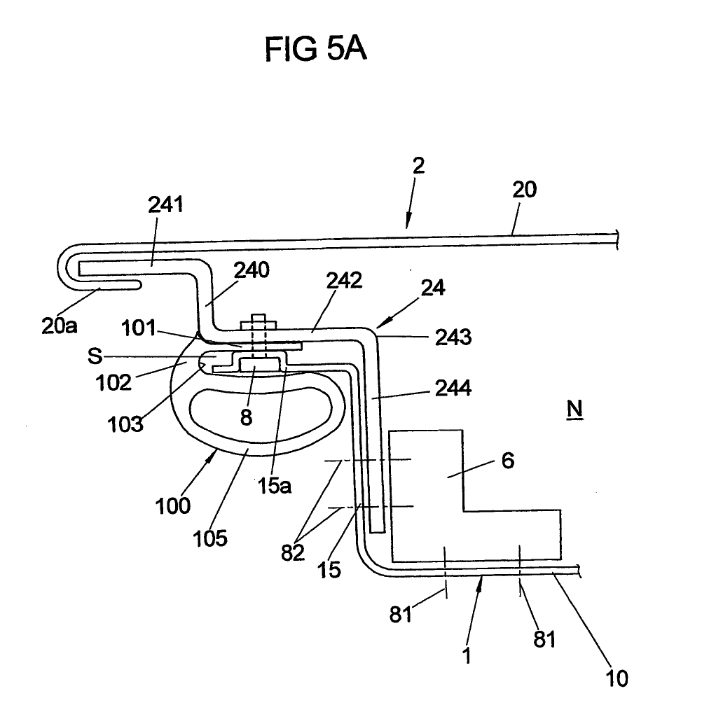

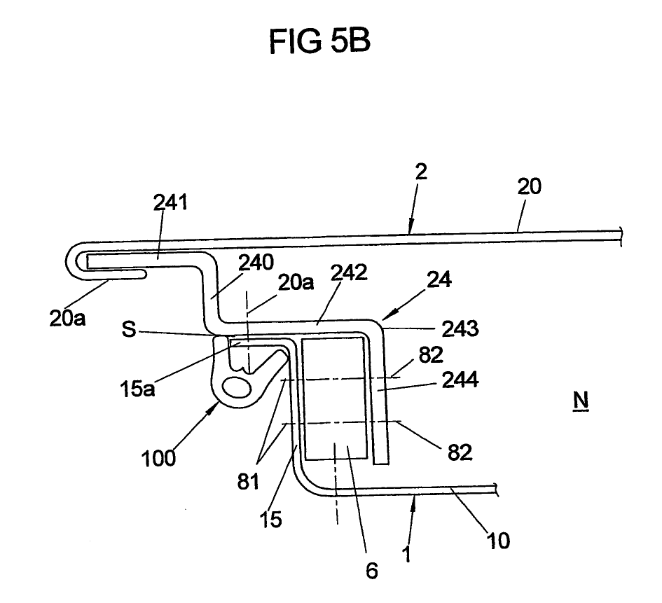

FIG. 5a shows a further development of the arrangement of FIGS. 4a and 4b whereby in addition a lock unit 6 is mounted in the region of the lower end side of the vehicle door.

The section of the driver door of a vehicle shown in FIG. 5a in the region of the rear end side shows in concrete form an outer module 2 with a door outer shell 20 which engages along its turned edge 20a round a reinforcement region 24 of a separate reinforcement plate or reinforcement frame and is hereby connected to same.

The reinforcement region 24 comprises a section 240 which forms a constituent part of the end side of the vehicle door and extends substantially perpendicular to the door outer shell 20. From this is angled a section 241 which engages in the turned edge 20a of the door outer shell 20, as well as a second section 242 which serves to connect the reinforcement region 24 to the unit carrier 1 by a screw connection 8. This second angled section 242 is adjoined by a further section 244 of the rear reinforcement region 24 which in turn is aligned substantially perpendicular to the door outer shell 20 as well as the support plate 10 of the unit carrier 1 and thus forms together with the first mentioned section 240 of the reinforcement region 24 the end side of the door module which runs substantially perpendicular to the support plate 10 and the door outer shell 20.

The two angled sections 241, 242 of the reinforcement region 24 thereby each run substantially parallel to the door outer shell 20 as well as the support plate 10 of the unit carrier 1.

A reinforcement region 15 is angled outwards on the support plate 10 (towards the door outer shell 20) and extends substantially along the one section 244 of the reinforcement region 24 of the outer module 2 defining the end side of the vehicle door. At one end a fixing region 15a is in turn angled from this to extend along the section 242 of the reinforcement region 24 which serves for fixing on the unit carrier 1. The unit carrier 1 and the door outer shell 2 are connected there by a screw connection 8 comprising a screw as well as an associated nut whereby the screw of the screw connection 8 engages through the fixing region 15a of the unit carrier 1 as well as through the section 242 of the reinforcement region 24 serving for fixing. The fixing region 15a of the unit carrier 1 as well as the section 242 of the outer module 2 serving for fixing form in their overlapping area an interface S which—without a cover—is visible when the vehicle door is opened to anyone viewing the end side of the vehicle door which is formed by the reinforcement region 24. At this interface S there is a sudden transition from the outer module 2 painted with the colour of the car to the unit carrier 1 which is normally painted in a neutral colour.

Here the transition area is however sealed and covered by a sealing member 100 which extends along the interface S and which has a fixing section 101 in the form of a foot of the sealing member 100 which in turn extends between the fixing region 15a of the unit carrier 1 and the section 242 of the reinforcement region 24 which serves for fixing, is clamped between same and in addition is penetrated by the screw of the screw connection 8 previously described. The fixing region 15a of the unit carrier 1 thereby engages in a recess 103 of the sealing member which is formed between the sealing foot 101 and the sealing body 105.

The sealing body 105 of the sealing member 100 in the closed state of the vehicle door bears against the vehicle body and thus seals the vehicle interior from the outer space provided on the other side of the vehicle door. This also produces a damping of external noises. Furthermore the said sealing member 100 also seals the connection point (interface S) between the unit carrier 1 and outer module 2.

From FIG. 5a it can also been seen that the sealing body 105 (main sealing area) of the sealing member 100 is connected to the sealing foot 101 through a bending or hinged area 102. The sealing body 105 which covers the screw of the screw connection 8 can thereby be folded round along a direction R so that the screw connection 8 is released for actuation through a tool. The connection between the unit carrier 1 and outer module 2 can be released by actuating the screw connection 8 with a suitable tool so that the outer module 2 can be removed from the unit carrier 1 and the electrical and mechanical function elements which are located between the unit carrier 1 and the outer module 2 in the wet space N of the vehicle door, such as e.g. the door lock 6 become accessible for repair or service work.

The lock assembly 6 of a door lock illustrated in FIG. 5a is prefitted on the support plate 10 of the unit carrier 1 by fixings 81 shown diagrammatically e.g. in the form of screws. This means the corresponding fixing between the lock assembly 6 and the support plate 10 is already carried out before the unit carrier 1 is fitted to the outer module 2. The lock assembly is hereby already fixed in its position relative to the unit carrier 1.

After later connecting the unit carrier 1 to the outer module 2 through the reinforcement region 24 an additional fixing of the lock assembly 6 on both the unit carrier 1 and on the reinforcement region 24 is then carried out by further suitable fixing elements 82, e.g. in the form of screws whereby the fixing elements 82 on one side engage through the reinforcement region 15 of the support plate 1 angled perpendicular to the support plate 10 and on the other side engage through the second end section 244 of the rear reinforcement region 24 which is likewise angled perpendicular to the support plate 10. With these further fixing means 82 the unit carrier 1 and the reinforcement region 24 of the outer module 2 are fixed against each other additionally in an angled region relative to the fixing regions 15aa, 242 forming the interface S (either side of an angle or corner 243) so that a particularly secure connection is provided between the unit carrier 1 and the reinforcement region 24, with a simultaneous integration of the lock assembly 6 and a correspondingly stable hold of the lock assembly 6 on the unit carrier 1 and on the reinforcement region 24 of the outer module 2.

FIG. 5b shows a modification of the arrangement of FIG. 5a whereby the difference is that the lock assembly 6 is prefitted on the angled reinforcement region 15 of the unit carrier 1 and furthermore (after connecting the unit carrier 1 and outer module 2) is fixed on the second end section 244 of the reinforcement region 24. This second end section 244 of the reinforcement region 24 runs parallel to the angled reinforcement region 15 of the unit carrier 1 and is spaced from same so that the lock assembly 6 can be housed between the reinforcement region 15 of the unit carrier 1 and the second end section 244 of the reinforcement region 24.

Also here the unit carrier 1 and the outer module 2 or its reinforcement region 24 are fixed against each other on one side by a screw connection 8 along two regions 15a, 242 running parallel to the support plate 10 and outer shell 20 and serving for fixing, and on the other side (through the lock assembly 6) to two regions 15, 244 of the support plate 10 and reinforcement region 24 respectively extending perpendicular thereto.

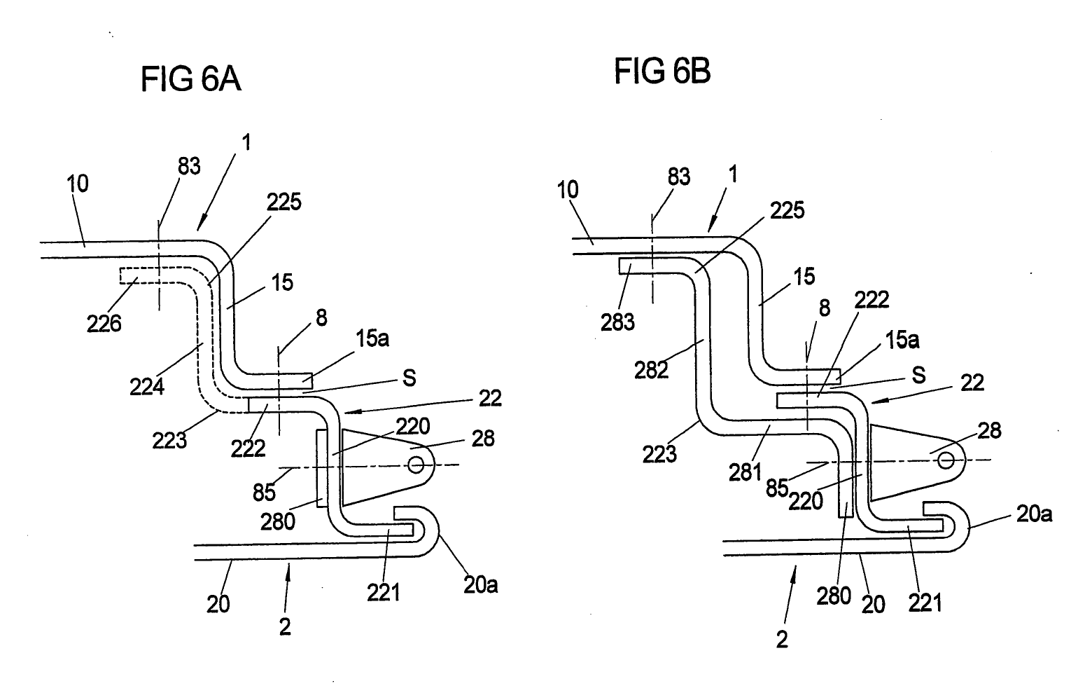

FIGS. 6a and 6b each show the fixing of a hinge part 28 on the front end side of a passenger door which is formed by a front reinforcement region 22 of the outer module 2. This reinforcement region has an end section 220 extending substantially perpendicular to the support plate 10 of the unit carrier 1 and to the outer shell 20 of the outer module 2 and on which the hinge component 28 is to be fixed, as well as a first section 221 which is angled herefrom and is engaged by a turned end 20a of the outer shell 20, and a second angled section 222 through which the reinforcement region 22 is connected by a screw connection 8 to the angled fixing region 15a of the support plate 1 through suitable fixing and connecting means 8.

As shown in FIG. 6a the front reinforcement region 22 of the outer module 2 can still be extended up to the support plate 10 of the unit carrier 1 and fixed there by further fixing means 83. Consequently the reinforcement region 22 has two further sections 224, 226 which extend along the reinforcement region 15 and support plate 10 of the unit carrier 1 and which are each associated with corresponding angles or corner sections 223, 225 of the reinforcement region 22 of the outer module 2.

On the side of the first end section 220 of the front reinforcement region 22 of the outer module 2 remote from the hinge part 28 there is a plate-type hinged reinforcement 280 which is penetrated by the fixing means 85 serving to fix the hinge 28 on the first end section 220 and used to stabilise the connection of the hinge.

It is clear from FIG. 6b that this hinge reinforcement 280 can be extended up to the support plate 10 of the unit carrier 1 whereby it extends with several sections 281, 282, 283 angled relative to each other first along the fixing region 15a, then along the reinforcement region 15 and finally along the support plate 10 of the unit carrier 1. An additional fixing of the hinge reinforcement 280 on the unit carrier 1 is provided there through suitable fixing means 83. In this case the extension of the front reinforcement region 22 of the outer module 2 explained with reference to FIG. 6a is then not required.

In FIGS. 6a and 6b the door sealing member 100 is not illustrated in order to clearly show that the interface S formed in the overlapping region of the fixing region 15a of the unit carrier 1 with the associated section 222 of the outer module 2 is visible to anyone viewing the end side of the vehicle door (when the vehicle door is opened) if it is not covered by a seal.

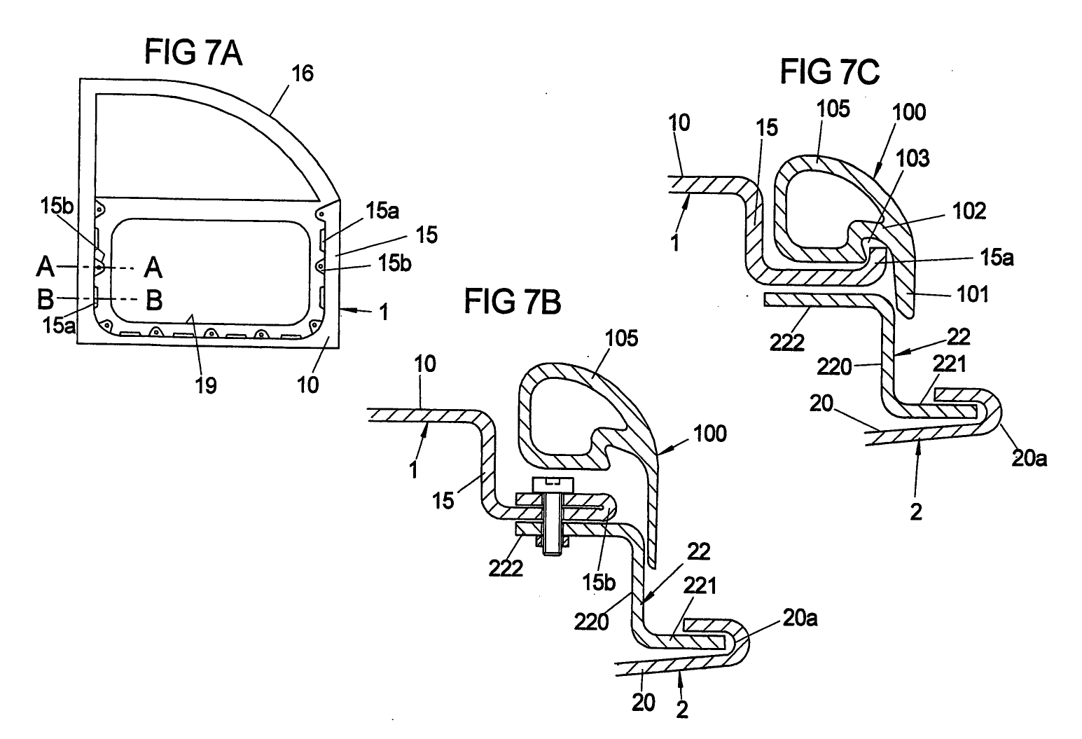

FIG. 7a shows for a passenger door a unit carrier 1 with a support plate 10 and a window frame 16 whereby the support plate 10 has a large surface area cut out section 19 which can be covered by a door module support which is to be fixed on the support plate 10 and has function groups already prefitted thereon, such as e.g. a window lifter, a side airbag module, a speaker system etc. With this embodiment the corresponding function components of the vehicle door are not prefitted directly on the support plate 10 of the unit carrier 1 but rather on a separate door module support which is then fitted on the support plate 10 together with the function components fixed thereon.

The unit carrier 1 has in its U-shaped circumferential reinforcement region 15 fixing regions 15a angled alternately in succession in the extension direction for fixing the door seal 100 by pushing on a push-on region of the door seal 100 formed by a recess 103 (see FIG. 7c) as well as double-layered fixing regions 15b formed by turning the angled end region to create a stable tear-resistant connection with the relevant section (e.g. 222) of the reinforcement region (e.g. 22) of the outer door module 2 serving for fixing (see FIG. 7b).

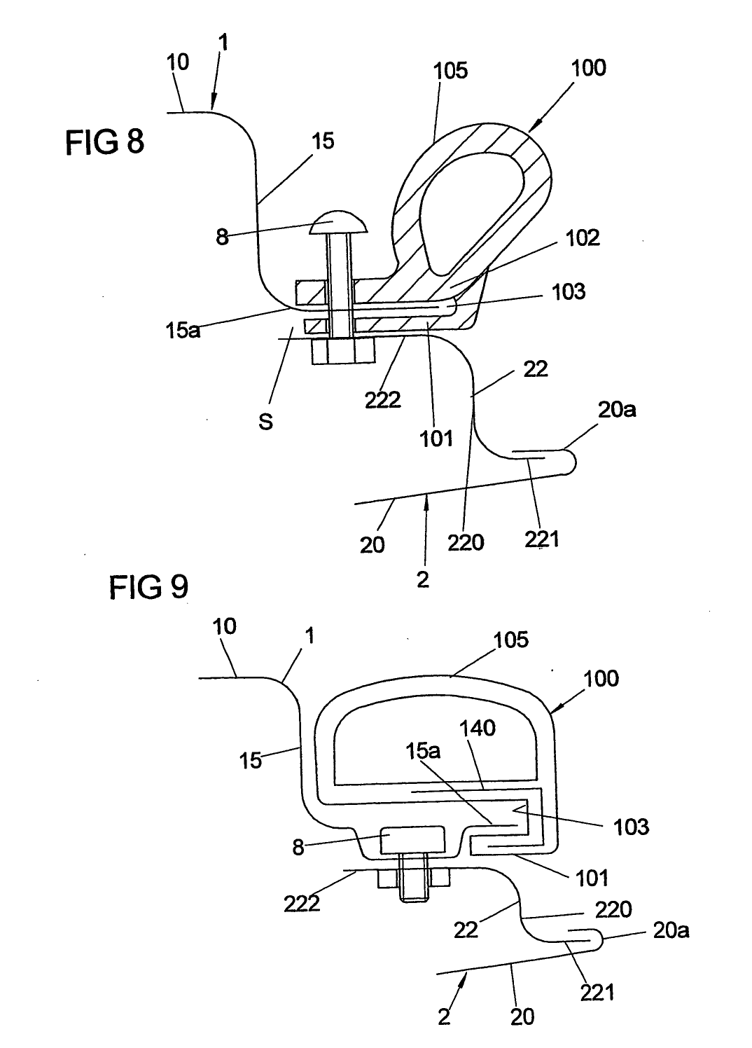

Different possibilities for fixing the door seal 100 on the door assembly formed by the unit carrier 1 and the outer module 2 will now be explained with reference to FIGS. 8 to 12.

According to FIG. 8 the door seal 100 is pushed with the push-on region formed by a recess 102 between the sealing body 105 and the sealing foot 101 onto the angled fixing region 15a of the unit carrier 1 and is fixed there additionally by the screw connection 8 through which the section 222 serving for fixing the front reinforcement region 22 of the outer module 2 is connected to the fixing region 15a of the unit carrier 1. The sealing member 100 has furthermore between the sealing foot 101 and the sealing body 105 a bending or hinged section 103 so that the sealing body 105 can be pivoted along a direction R away from the fixing means 8. These can hereby be released for actuation through a tool.

FIG. 8 thereby shows a situation in which the sealing body 105 is pivoted away from the screw connection along the said pivotal direction R so that the screw can be removed.

It is furthermore clear from FIG. 8 that the interface S of the connection between the unit carrier 1 and reinforcement region 22 is covered, depending on the viewing direction, partially through the sealing body 100, partially through the bending and hinged region 102 and partially through the foot 101 of the sealing member 100. The sealing foot 101, which extends between the fixing region 15a of the unit carrier 1 and the section 222 of the front reinforcement region 22 of the outer module 2 serving for fixing thereby seals the interface S between the reinforcement region 222 and the unit carrier 1.

With the embodiment illustrated in FIG. 9 the push-on region of the sealing member 100 which is formed by the recess 103 and defined by the sealing foot 101 and sealing body 105 and through which the sealing member 100 is pushed onto the fixing region 15a of the unit carrier 1, is reinforced by a metal insert 140 in the form of a metal core.

The sealing member 100 can hereby be pushed by its push-on region 103 so firmly onto the fixing region 15a in the form of a fixing flange and fixed through clamping action that an additional fixing by the screw connection 8 which serves to connect the unit carrier 1 and reinforcement region 22 of the outer module 2 is not required. The screw head of the screw connection is consequently sunk underneath the sealing body 105 of the seal 100 in a moulded depression of the fixing region 15a of the unit carrier 1. In order to release the screw connection 8 in the event of repair or service the sealing member 100 is hereby pushed in a part surrounding the screw connection 8 down from the fixing region 15a (fixing flange) of the unit carrier 1 so that the screw connection 8 is accessible for an actuating tool.

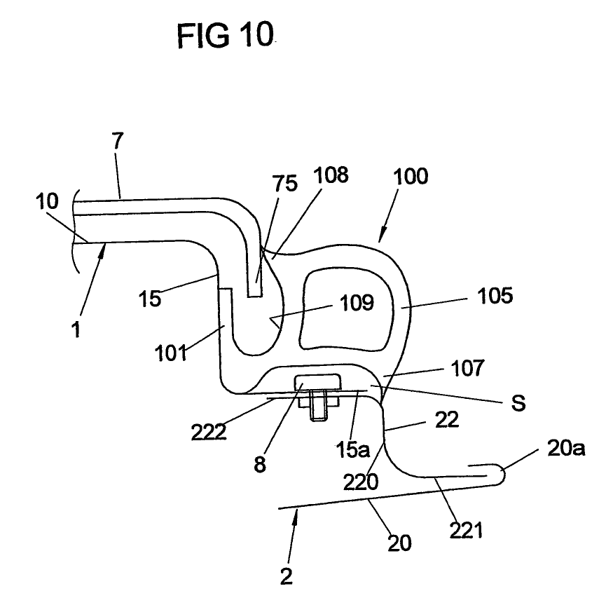

With the embodiment illustrated in FIG. 10 the sealing member 100 is fixed by its sealing foot 101 through adhesive against the angled reinforcement region 15 of the unit carrier 1. It has two projections 107, 108 in the form of lips protruding from its sealing body 105.

The one lip 107 serves to cover the interface S between the unit carrier 1 and outer door module 2. The other lip 108 serves to cover the angled free end 75 of a door inner trim 7 which covers the support plate 10 of the unit carrier 1 from the interior of the vehicle. By covering the free end 75 of the door inside trim 7 by the lip 108 of the seal 100 a clean cut of the (no longer visible) angled free end 75 of the door inside trim 7 is not necessary. Furthermore greater tolerances can be allowed regarding the arrangement of the door inside trim 7 on the unit carrier 1. Finally the angled end section 75 of the door inside trim 7 can be housed rattle-free in socket 109 formed between the sealing foot 101 and the projection 108 of the seal 100 associated with the door inside trim 7.

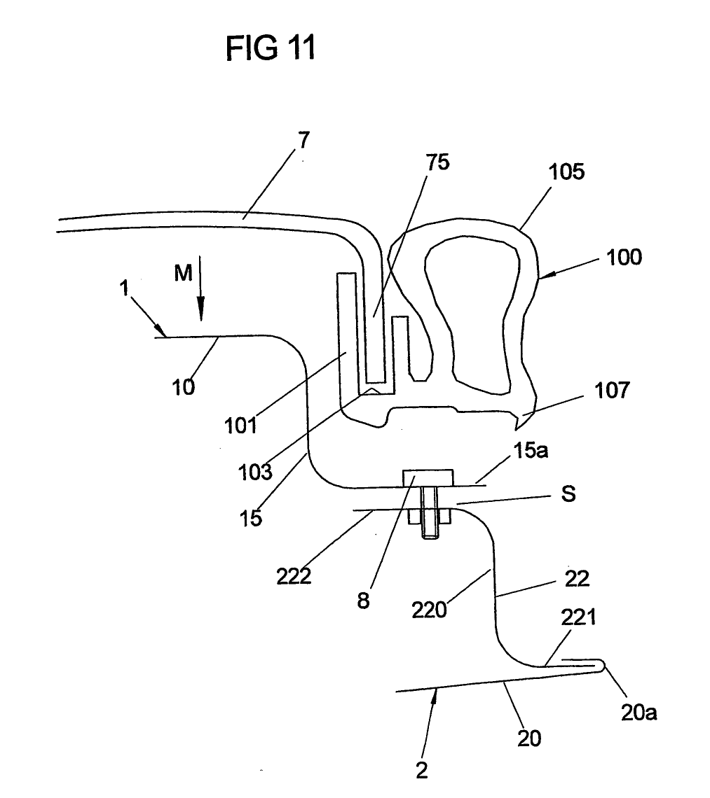

With the embodiment illustrated in FIG. 11 the sealing member 100 is pushed by a push-on region 103 formed as a recess between the sealing foot 101 and the sealing body 105 onto the angled end 75 of a door inside trim 7 and thereby prefitted on same. When fitting the door inside trim 7 onto the support plate 10 of the unit carrier 1 along an assembly direction M the sealing body 105 of the seal 100 engages through the screw connection 8 between the unit carrier 1 and outer module 2 and thereby covers with a projection 107 in the form of a sealing lip the interface S visible from the outside between the fixing region 15a (fixing flange) of the unit carrier 1 and the angled section 222 of the reinforcement region 22 of the outer module 2 serving for fixing.

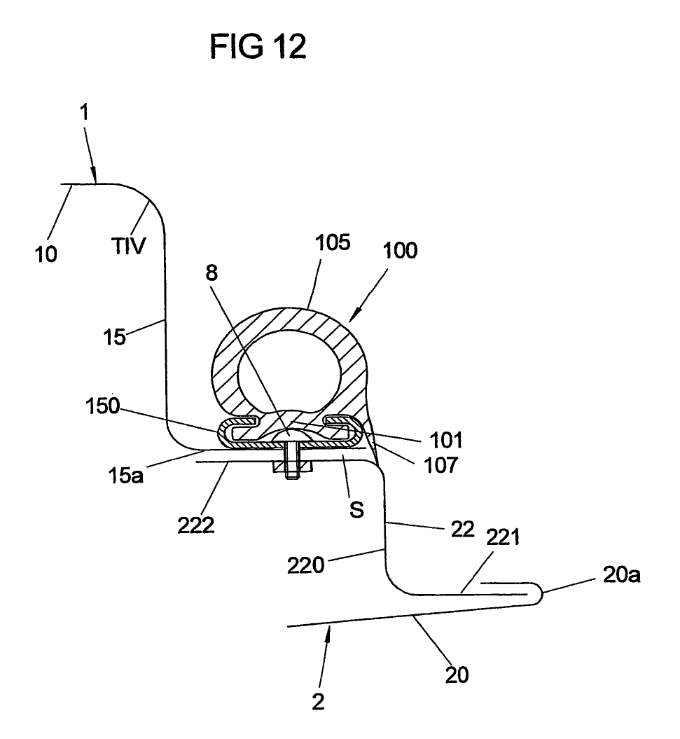

With the embodiment according to FIG. 12 an additional substantially C-shaped rail 150 is fixed on the fixing region 15a (fixing flange) of the unit carrier 1, namely by the screw connection 8 which also serves to fix the fixing region 15a of the unit carrier 1 on the reinforcement region 22 of the outer module 2. The seal 100 is mounted with positive engagement in this rail so that it covers the screw connection 8 by its sealing body 105 and with a projection 107 in the form of a sealing lip covers and seals the interface S between the unit carrier 1 and outer module 2 which is visible from the outside.

1. A motor vehicle door with
an outer module which has a door outer shell and forms an outer design surface of the vehicle door, and
a unit carrier which is mounted on the side of the outer module facing the interior of the vehicle and is connected to the outer module through forming an interface,
wherein
a sealing member extends along the interface between the unit carrier and outer module and covers the interface at least in part.

2. The motor vehicle door according to claim 1 wherein in the region of the interface there are fixings for connecting the unit carrier to the door outer module and that at least one part of the fixings is covered by the sealing member.

3. The motor vehicle door according to claim 2 wherein such fixings which would be visible on the outer contour of the vehicle door in the uncovered state are covered by the sealing member.

4. The motor vehicle door according to claim 2 wherein all the visible fixings located in the region of the interface are covered by the sealing member.

5. The motor vehicle door according to claim 1 wherein the sealing member forms a main seal of the vehicle door through which the vehicle door in the closed state bears against the vehicle body.

6. The motor vehicle door according to claim 2 wherein one of the sealing member and a section of the sealing member is movable so that the fixings are no longer covered and are exposed for actuation by a tool.

7. The motor vehicle door according to claim 6 wherein the section of the sealing member is movable by folding it round.

8. The motor vehicle door according to claim 6 wherein the sealing member has a pivotal region about which a section of the sealing member is foldable.

9. The motor vehicle door according to claim 6 wherein the sealing member is movable by sliding displacement.

10. The motor vehicle door according to claim 6 wherein the sealing member is movable into a position in which the fixing elements are exposed for actuation by a tool whereby the sealing member is held by the vehicle door.

11. The motor vehicle door according to claim 7, wherein the fixings can be exposed by folding round one section of the sealing member whereby at least a further section of the sealing member remains fixed on the vehicle door.

12. The motor vehicle door according to claim 11 wherein the sealing member is displaceable along a fixing region of the motor vehicle door so that the fixings are released without having to remove the sealing member completely from the fixing region.

13. The motor vehicle door according to claim 1 wherein a fixing region is provided on the vehicle door to which the seal is fixable through positive locking connection.

14. The motor vehicle door according to claim 13 wherein the sealing member can be pushed onto or into the fixing region in order to form a push-fit connection.

15. The motor vehicle door according to claim 14 wherein the fixing region is formed through a fixing flange.

16. The motor vehicle door according to claim 14 wherein the fixing region is formed through a fixing rail.

17. The motor vehicle door according to claim 1 wherein the sealing member is clamped with a section between the unit carrier and outer module and forms an anti contact corrosion intermediate layer.

18. The motor vehicle door according to claim 1 wherein the sealing member is fixed on the motor vehicle door by separate fixings, more particularly in the form of a screw connection.

19. The motor vehicle door according to claim 1, wherein the sealing member has a metal insert which comprises a fixing section of the sealing member.

20. The motor vehicle door according to claim 1 wherein the sealing member can be prefitted on the unit carrier before the unit carrier and outer module are fitted together.

21. The motor vehicle door according to claim 20 wherein the sealing member is fixable in a pre-assembly position on the unit carrier and once the outer module and unit carrier have been connected together is movable, more particularly slid from the pre-assembly position into its functioning position.

22. The motor vehicle door according to claim 20 wherein the sealing member is prefitted on the unit carrier in its functioning position and in order to connect the outer module to the unit carrier is movable, more particularly folded round or pushed along so that fixing points are exposed for connecting the outer module to the unit carrier.

23. The motor vehicle door according to claim 15 wherein the sealing member is only to be mounted on the vehicle door after the outer module and unit carrier have been connected together.

24. The motor vehicle door according to claim 15 wherein positive locking elements are provided, more particularly moulded on the unit carrier, more particularly on the edge area thereof through which the sealing member is fixable with positive engagement on the unit carrier.

25. The motor vehicle door according to claim 1 wherein a door inside trim, where necessary including edge fascia panels, is mounted on the unit carrier.

26. The motor vehicle door according to claim 25 wherein the door inside trim covers the unit carrier in the visible area.

27. The motor vehicle door according to claim 25 wherein the sealing member covers the interface between the unit carrier and door inside trim.

28. The motor vehicle door according to claim 27 wherein the interface is covered by a projection protruding from the sealing member.

29. The motor vehicle door according to claim 25 wherein the sealing member is fixed on the door inside trim.

30. The motor vehicle door according to claim 1 wherein at least a part of the electrical or mechanical function elements is mounted on a surface of the unit carrier facing the outer module so that the function elements are mounted between the outer module and the unit carrier.

31. The motor vehicle door according to claim 1 wherein the outer module has reinforcement areas in the region of its outer edges.

32. The motor vehicle door according to claim 31 wherein the reinforcement areas protrude inwards from the outer module.

33. The motor vehicle door according to claim 31 wherein the reinforcement areas run along the edge of the outer module.

34. The motor vehicle door according to claim 31 wherein the reinforcement areas form at least one separate module which is fixed on the door outer shell.

35. The motor vehicle door according to claim 1 wherein a cross support for strengthening the outer module is provided on the outer module.

36. The motor vehicle door according to claim 1 wherein a window frame is integrated in the unit carrier.

37. The motor vehicle door according to claim 1 wherein the outer module and unit carrier have different colours.

38. The motor vehicle door according to claim 1 wherein the unit carrier extends substantially up to the side edges of the motor vehicle door.

39. The motor vehicle door according to claim 1 wherein the unit carrier has reinforcement areas in the region of its outer edges.

40. The motor vehicle door according to claim 39 wherein the reinforcement areas are formed at least in part around the periphery of the unit carrier and protrude outwards.

41. The motor vehicle door according to claim 39 wherein the reinforcement area runs substantially U-shaped around the edge of the unit carrier.

42. The motor vehicle door according to claim 39 wherein the unit carrier is made of metal, more particularly sheet metal, and the reinforcement areas are formed on the unit carrier more particularly by stamping or deep-drawing.

43. The motor vehicle door according to claim 39 wherein the unit carrier and the outer module bear against one another through their reinforcement areas.

44. The motor vehicle door according to claims 39 wherein fixing points for connecting the outer module to the unit carrier are provided on the reinforcement areas of the unit carrier and outer module.

45. The motor vehicle door according to claim 1 wherein the unit carrier and the outer module are fixed against each other along an overlapping area which in cross-section is angled at least once.

46. The motor vehicle door according to claim 1 wherein a lock module of a door lock is prefitted on the unit carrier.

47. The motor vehicle door according to claim 1 wherein a lock module of a door lock is fixed on an overlapping area of the outer module and unit carrier.

48. The motor vehicle door according to claim 1 wherein at least one hinge part of a door hinge is fixed on the motor vehicle door.

49. The motor vehicle door according to claim 48 wherein the hinge part is fixed on an overlapping area of the unit carrier and outer module.

50. The motor vehicle door according to claim 48 wherein the hinge part is fixed to a hinge reinforcement in an overlap area of the outer module.

51. The motor vehicle door according to claim 1 wherein the unit carrier is turned over at least at a part of the fixing points used to connect with the outer module so that the material of the unit carrier becomes double-layered at this point.

52. The motor vehicle door according to claim 51 wherein the edge of the unit carrier between the double-layered fixing points is designed to receive the sealing member.

53. A motor vehicle door comprising
an outer module which has a door outer shell and forms an outer design surface of the vehicle door, and
a unit carrier which is mounted on the side of the outer module facing the interior of the vehicle and is connected to the outer module through forming an interface, wherein
a sealing member extends along the interface between the unit carrier and outer module and covers the interface at least in part; and fixings are provided in the region of the interface for connecting the unit carrier to the door outer module; and all such fixings which would be visible on the outer contour of the vehicle door in the uncovered state are covered by the sealing member.
